(19) United States
(12) Patent Application Publication
(10) Pub. No.: US 2013/0205583 A1
(43) Pub. Date: Aug. 15, 2013

(54) Easy Bilge

(71) Applicant: Thomas Gerald Payne, Cocoa, FL (US)

(72) Inventor: Thomas Gerald Payne, Cocoa, FL (US)

(21) Appl. No.: 13/396,222

(22) Filed: Feb. 14, 2012

(51) Int. Cl. B23P 19/00

(52) U.S. Cl. 29/700

(57) ABSTRACT

The easy bilge is designed to make the replacement or installation of bilge pumps or other instruments in tight spaces easy to achieve. The bilge pump or other device is fastened to the assembly arm which is fastened to the mounting plate. The mounting plate is in turn epoxied to the interior hull of the boat. This makes it so the assembly arm can be removed at any time to replace any instrument or pump and be reinserted with little or no effort.

### BACKGROUND OF INVENTION

This invention is in the field of marine repair. It is to aid in the solution of changing and installing bilge pumps or instruments. These pumps and instruments are generally located in hard to reach and, sometimes, dangerous areas. This invention is designed to alleviate or completely eliminate such problems.

### SUMMARY OF INVENTION

This device was designed to aid a mechanical technician to a novice in the installation of pumps and instruments located in difficult-to-access areas of a boat or other vessels. It does this by attaching an anchor point to a flat surface so the assembly arm that will hold pumps or instruments can be easily attached and removed at a later date for repairs or updates. This will eliminate the difficulty in the installation of any instrument or pump which will aid in a speedy and correct repair. Bilge pumps and other such instruments are often located under engines or transmissions, pump-out areas, hazardous areas, and other difficult to access places. This invention would keep the technician from putting his or her hands in a dangerous position and allows the technician to easily replace or install these parts.

### BRIEF DESCRIPTION OF THE DRAWING

In the drawing page

FIG. 1 depicts the assembly arm. The assembly arm's design is for the sole purpose of an anchor point for instruments bilge pumps (as seen in the diagram).

FIG. 2 is a side view of FIG. 1 the assembly arm.

FIG. 3 is the mounting plate that anchors to a flat surface (i.e. interior hull surface) using epoxy without the need to drill and screw into the hull. This allows one to mount FIG. 1, the assembly arm, to FIG. 3, the anchor plate, to the hull or surface with a simple no. 8 stainless steel screw through FIG. 1, the assembly arm, into the mounting plate not the hull.

FIG. 4 is a side view of the mounting plate, FIG. 3.

FIG. 5 depicts the installation of the assembly with a bilge pump and float switch for illustrative purposes. FIG. 5 also shows the complete mounting design.

### DETAILED DESCRIPTION OF THE INVENTION

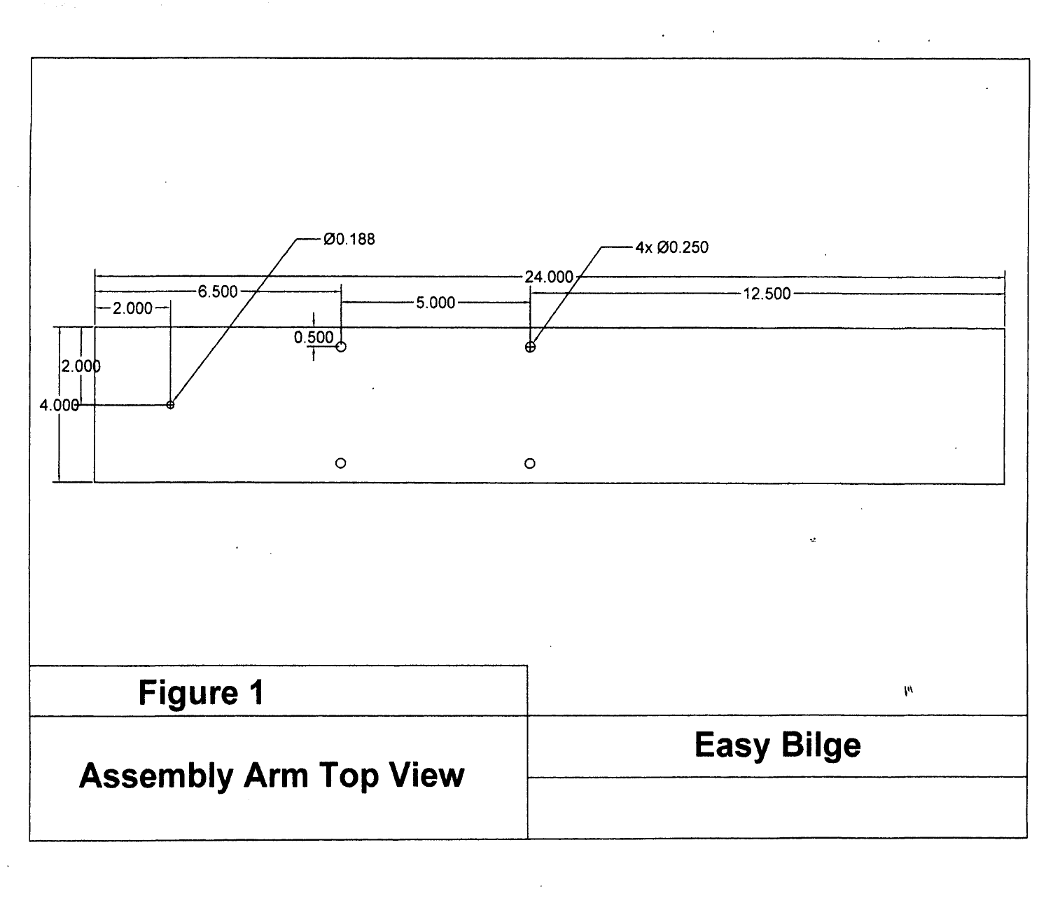

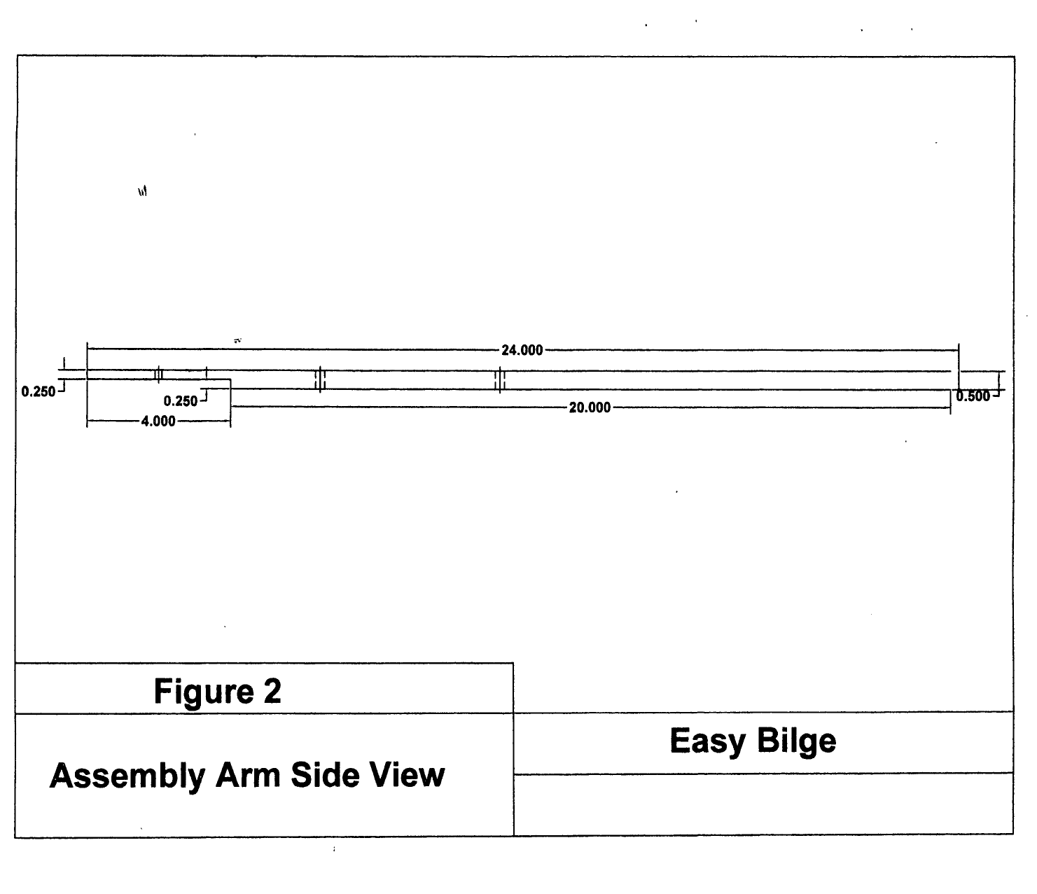

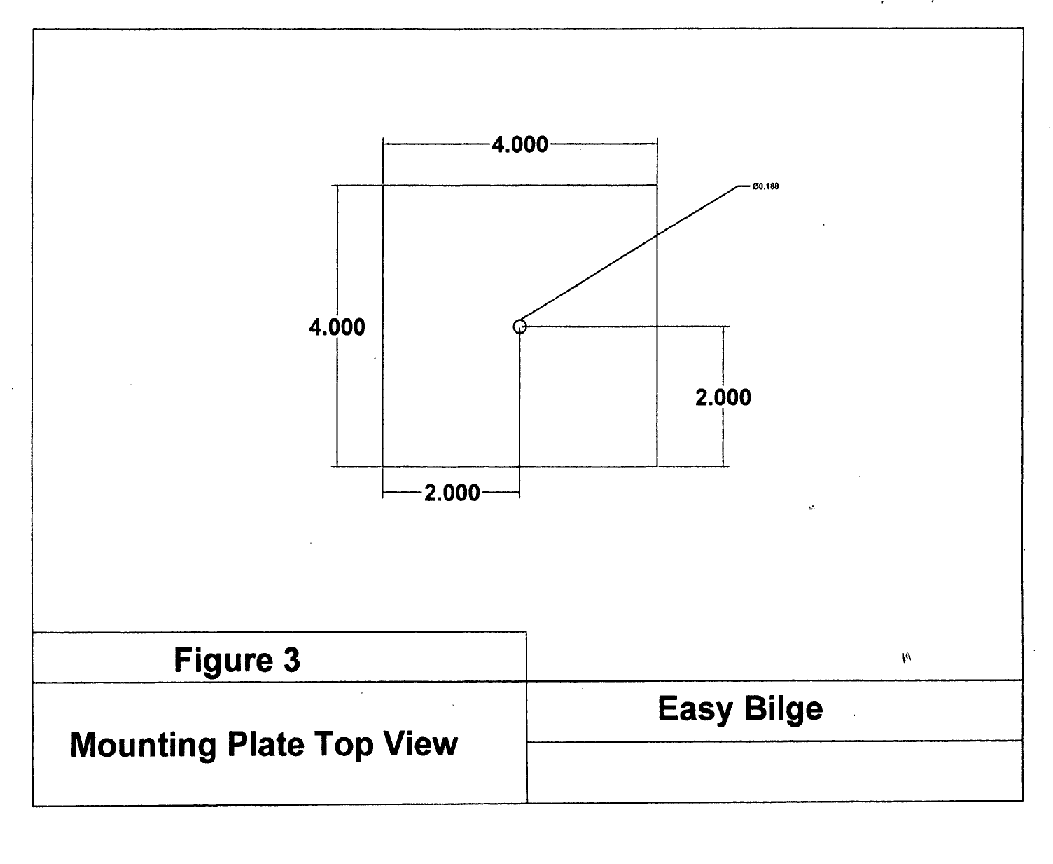

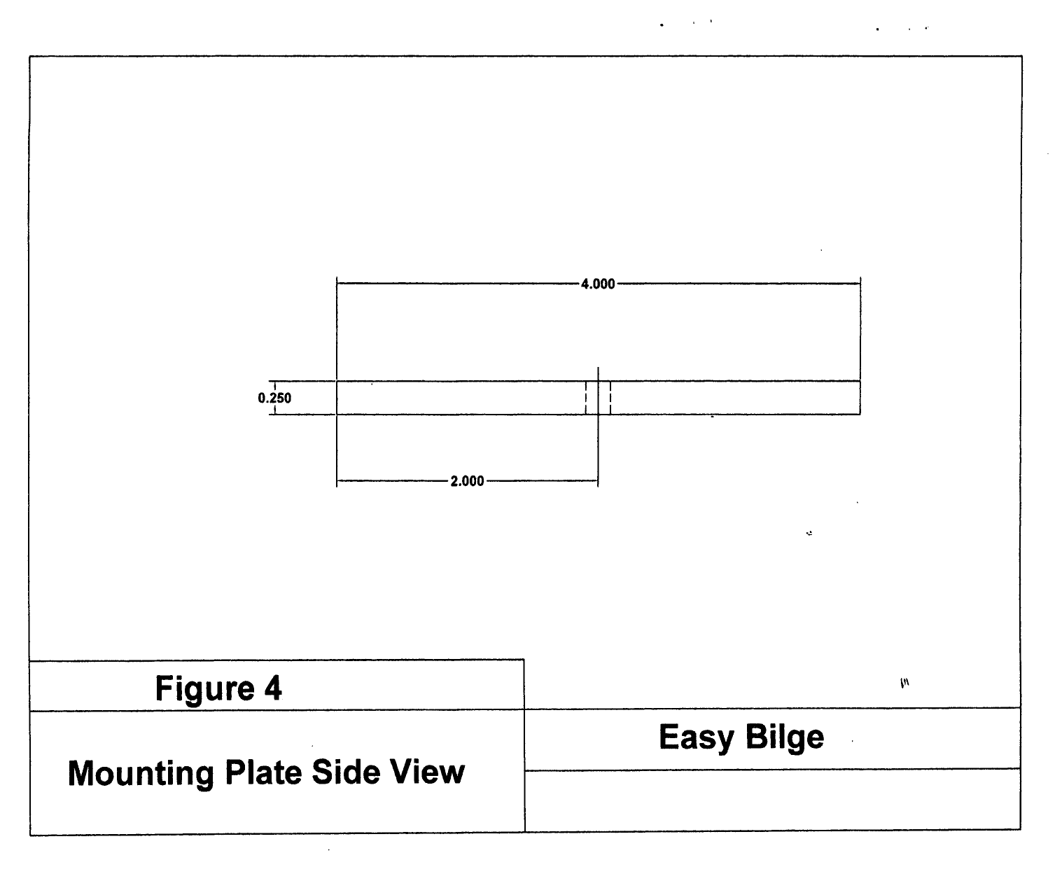

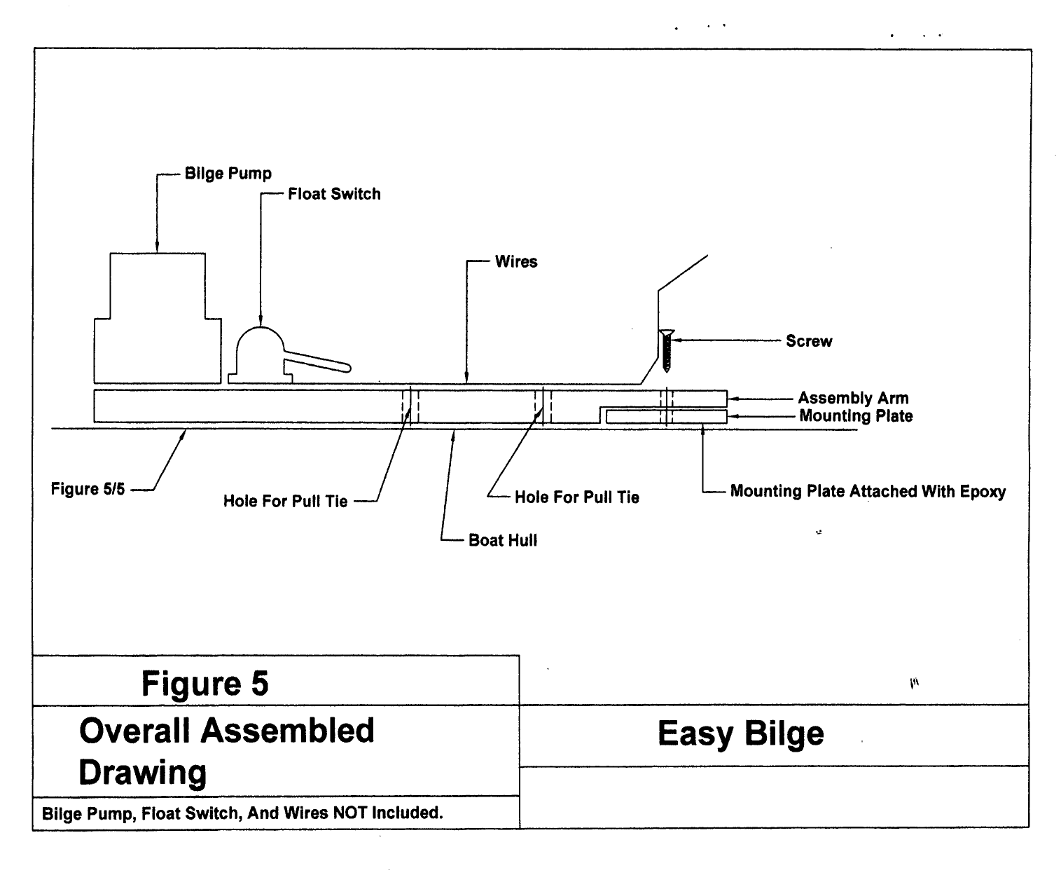

This product is intended to make the installation or replacement of pumps and instruments much easier. It is primarily used for, but is not limited to, the installation of bilge pumps under the engine in a boat or other vessel. Previously bilge pumps have been tucked under motors where they can be difficult or even hazardous to reach. This invention is manufactured from a polymer with five holes drilled into it. It also involves an anchor plate made from a polymer with a hole drilled in it. To install the product first clean the area that the mounting plate, FIG. 3 and FIG. 4, will be resting on. Once the area is clean apply epoxy to the mounting plate area as well as the mounting plate itself. Apply the plate to the area and allow the epoxy to set up as per manufacturer's recommended drying time. Next take the assembly arm and determine what the correct length for the arm will be and cut the arm to the desired length. On the assembly arm, or FIG. 1 and FIG. 2, assemble the bilge pump and float switch, or whatever other instrument or pump desired. Once the desired instruments or pumps are attached to the assembly arm and the wires from the pump or instruments are secured to the assembly is (FIGS. 1 and 2), place the assembly arm over the mounting plate and fasten them together with a no. 8 stainless steel screw. The assembly of the invention is now complete, as seen in FIG. 5, and the pump or other instrument is now installed with little or no inconvenience. And if at a later date service is required to pumps, instruments, etc. removal of the fastener (no. 8 stainless screw) makes it possible to retrieve the assembly arm (FIGS. 1 and 2) and service the instruments, pumps, etc. Then simply return the assembly arm to the original position and reinstall the no. 8 screw. The system is now ready to be put back into service.

1. An apparatus for the ease of installing or replacing bilge pumps, float switches, etc. by attaching them to a device that allows you to access areas that are normally inaccessible; this invention subsequently attaches to an anchoring plate that is attached to the interior hull or other surface which includes, but is not limited to: watercraft and motor vehicles.
